(19) United States
(12) Patent Application Publication
(10) Pub. No.: US 2022/0190410 A1
(43) Pub. Date: Jun. 16, 2022

(54) STRUCTURAL COMPOSITE LAMINATE STRUCTURE FOR AN AIRCRAFT PART, AIRCRAFT PART MANUFACTURED WITH SUCH A LAMINATE AND AIRCRAFT

(71) Applicant: Airbus Operations GmbH, Hamburg (DE)

(72) Inventors: Peter LINDE, Hamburg (DE); Matthias HEGENBART, Hamburg (DE)

(21) Appl. No.: 17/550,922

(22) Filed: Dec. 14, 2021

(30) Foreign Application Priority Data
Dec. 16, 2020 (DE) 102020133854.6

(51) Int. Cl. H01M 16/00; B32B 5/02; H01G 11/08; H01G 11/66; H01G 11/28; B64C 1/00

(52) U.S. Cl. CPC H01M 16/006; B32B 5/02; H01G 11/08; H01G 11/66; H01G 11/28; B64C 1/00; H01M 2004/8694; B32B 2457/16; B32B 2307/206; B32B 2260/021; B32B 2457/10; B32B 2457/18; B32B 2605/18

(57) ABSTRACT

With the measures described herein, a structural composite laminate is provided that includes a structural fuel cell, a structural supercondensator and a structural battery. Each of these components is configured in a self-supporting manner, such that aircraft parts, like exterior panels, may be manufactured from the laminate. The aircraft parts are capable of generating electrical energy by means of the structural fuel cell and distribute the electrical energy over the whole aircraft without cabling. Furthermore, short power demand peaks can be absorbed by the structural supercondensator, whereas the basic load is supplied by the structural battery.

### CROSS-REFERENCES TO RELATED APPLICATIONS

This application claims the benefit of the German patent application No. 102020133854.6 filed on Dec. 16, 2020, the entire disclosures of which are incorporated herein by way of reference.

### FIELD OF THE INVENTION

The invention relates to a structural composite laminate structure for an aircraft component. The invention further relates to an aircraft component and an aircraft comprising such a structural composite laminate structure.

### BACKGROUND OF THE INVENTION

U.S. Pat. No. 9,520,580 B2 discloses an electrochemical appliance installed in a composite component.

### SUMMARY OF THE INVENTION

It is an object of the invention to integrate a structural fuel cell, a structural battery and a structural supercapacitor into the same component of an aircraft cell.

The invention provides a structural composite laminate structure for an aircraft component, in particular a self-supporting primary structural component, of an aircraft, wherein the composite laminate structure comprises a plurality of structural layer structures stacked on top of one another, namely
a structural fiber composite layer structure made of a fiber composite material;
a structural energy generation layer structure which forms a fuel cell, and which is applied to the fiber composite layer structure;
a structural supercapacitor layer structure which forms a supercapacitor; and
a structural battery layer structure which forms a structural battery, and which is applied to the supercapacitor layer structure.

The fiber composite layer structure preferably has an outer fiber composite layer region which is arranged on an outside of the composite laminate structure, which forms an outer skin, and which is applied to the energy generation layer structure.

The fiber composite layer structure preferably has an integrated fiber composite layer region which is arranged as fiber composite intermediate layer between the energy generation layer structure and the supercapacitor layer structure.

The fiber composite layer structure preferably comprises an insulating fiber composite layer which is applied to the energy generation layer structure.

The outer fiber composite layer region preferably comprises a plurality of outer fiber composite layer sublayers, where a part of the fiber composite layer sublayers facing the energy generation layer structure is made of insulating glass fiber sublayers in order to form an insulating fiber composite layer.

The outer fiber composite layer region preferably comprises a plurality of outer fiber composite layer sublayers, where a part of the fiber composite layer sublayers facing away from the energy generation layer is made of carbon fiber sublayers.

The integrated fiber composite layer region preferably comprises a plurality of outer fiber composite layer sublayers, where a part of the fiber composite layer sublayers facing the energy generation layer structure is made of insulating glass fiber sublayers in order to form an insulating fiber composite layer.

The integrated fiber composite layer region preferably comprises a plurality of outer fiber composite layer sublayers, where a part of the fiber composite layer sublayers facing away from the energy generation layer is made of carbon fiber sublayers.

The energy generation layer structure preferably comprises an ion-conducting separation layer, a first gas distributor layer and a second gas distributor layer, which each adjoin the ion-conducting separation layer and distribute gas in a layer plane, and an electrically conductive cathode layer, which adjoins the first gas distributor layer, and an electrically conductive anode layer, which adjoins the second gas distributor layer.

The ion-conducting separation layer preferably comprises a plurality of separation layer sublayers, where one separation layer sublayer is a proton exchange membrane and at least one separation layer sublayer applied to the proton exchange membrane is a catalyst membrane coated with a catalyst suitable for a fuel cell reaction.

The first gas distributor layer and/or the second gas distributor layer preferably comprise a plurality of gas distributor sublayers, where a part of the gas distributor sublayers facing away from the ion-conducting separation layer forms a gas diffusion sublayer and/or where a part of the gas distributor sublayers applied to the ion-conducting separation layer forms a microperforated sublayer.

The cathode layer and/or the anode layer preferably have a plurality of bipolar plate sublayers and current collector sublayers, where each bipolar plate sublayer is a composite sublayer, preferably carbon composite sublayer, which contains at least one gas channel and/or where each current collector sublayer is a composite sublayer containing a metal.

The supercapacitor layer structure preferably comprises a first current collector layer and a second current collector layer between which a supercapacitor layer is arranged, where the first current collector layer is applied adjoining the energy generation layer structure and where the second current collector layer is applied adjoining the battery layer structure.

The first current collector layer and/or the second current collector layer preferably contains an electrode sublayer which is composed of carbon fibers and is applied to the supercapacitor layer.

The supercapacitor layer preferably comprises a plurality of electrolyte sublayers, preferably composed of a polymer electrolyte, where at least two electrolyte sublayers are each applied separately from one another to the first current collector layer and to the second current collector layer, and at least one separator sublayer, preferably composed of insulating glass fiber composite material, where the separator sublayer electrically insulates at least two electrolyte sublayers from one another and is applied to these.

One of the current collector layers preferably comprises a current collector sublayer which contains metal and is applied adjoining the fiber composite layer structure, preferably to the integrated fiber composite layer region.

The battery layer structure preferably comprises a battery layer which comprises a negative electrode sublayer and a positive electrode sublayer which are separated from one another by a separator sublayer, where each sublayer of the battery layer contains a structural electrolyte.

The battery layer structure preferably comprises a plurality of current collector sublayers which are each applied to the negative electrode sublayer and the positive electrode sublayer and/or where the battery layer structure comprises an insulating glass fiber separator which separates the battery layer structure from the supercapacitor layer structure and is applied thereto.

The composite laminate structure preferably comprises an integrated control unit which is configured for controlling the generation, storage and retrieval of electric energy by the energy generation layer structure, the supercapacitor layer structure and the battery layer structure, where the control unit is electrically conductively connected to these layer structures and where the control unit is fluidically connected to the energy generation layer structure in order to introduce and discharge fluids.

The invention provides an aircraft component, preferably exterior panel, for an aircraft, where the aircraft component is made of a composite laminate comprising a composite laminate structure as described above.

The invention further provides an aircraft containing at least one such aircraft component.

The invention provides a process for producing an energy generation layer structure for a composite laminate structure, wherein the energy generation layer structure is formed by laying down fiber sublayers, where the first gas distributor layer or the second gas distributor layer is formed by laying down carbon fiber sublayers in which a gas channel has been formed by removal of material, preferably removal of material by laser.

One idea is to create an improved structural fuel cell which is integrated into a structural laminate. The fuel cell is combined with a structural battery laminate and a supercapacitor laminate in a single part in order to combine the advantages of the structural fuel cell, the structural battery and the structural supercapacitor and avoid the individual disadvantages thereof

On the basis of the ideas described herein, fuel cells can be integrated better into primary structures or aircraft cells of aircraft and spacecraft together with structural battery laminates and structural supercapacitors. In this way, the various complementary functions of generation, storage and (more rapid) retrieval of stored electricity can be integrated into the aircraft cell or spacecraft cell, which makes a lighter-weight solution in the overall system possible. The ideas explained herein are generally applicable to aircraft. It is ultimately an objective of these measures to reduce emissions during air travel and thus also reduce the environmental footprint.

The advantages of the battery are combined with those of the supercapacitor, with the advantages of the structural fuel cell at the same time being combined with the advantages of the structural laminate. The structural laminate is usually a carbon fiber-reinforced composite (carbon fiber reinforced plastic, CFRP).

Due to the fuel cell, an electric energy generation function can be obtained by means of hydrogen and oxygen from the CFRP laminate. The integration of the energy source or the energy generator into the structure of the aircraft or spacecraft makes it possible to avoid complicated cable connections. Furthermore, resistance losses can be greatly decreased.

The composite laminate structure has a number of functions: structural function, energy supply, passive cooling due to a large surface area.

The fuel cell layers do not require separate cables or wires. Furthermore, the system does not have to be separately integrated into the primary structural laminate. As a consequence, cable clamps or conduits are also no longer necessary.

No separate installation work arises as a result of the invention because manual installation can be dispensed with. Furthermore, no additional housings or structures are necessary because the energy supply and the control unit are integrated in a single part.

In addition, the structural fuel cell can have improved power and efficiency because of the integration. The fuel cells can be produced more simply; they have fewer components and are formed directly by sublayers of the structural laminate.

Faster production is thus also possible. The integration also allows a weight and cost saving. A greater structural efficiency of the overall system is likewise possible as a result of the functional integration into a laminate or panel.

The composite laminate and the corresponding regions can be charged and discharged quickly. It has a long life and high fatigue resistance. Furthermore, the energy density and also the power density can be increased.

The structural supercapacitor sublayers allow a rapid reaction, while long-term storage capability is ensured by the structural batteries. The energy generation sublayers and the energy storage sublayers are arranged in a sandwich structure together with structural CFRP sublayers and form a combined structural battery having a structural supercapacitor and a structural fuel cell in a laminate, in order to form a multifunctional laminate for energy storage and energy supply.

When energy consumers such as heating, engine and the like are switched on, energy peaks usually arise. The current and voltage peaks can be provided more readily by supercapacitors, while long-term storage is provided by the structural battery. Energy generation is effected by the structural fuel cell. All layers of the multifunctional laminate provide a load-bearing function.

The structural supercapacitor layers in the structural laminate provide the capability of storing a useful amount of energy for a comparatively short period of time (from a few seconds to a few minutes). The supercapacitor layers function as energy reservoirs which assist the function of the structural battery. Peaks in demand from electric and electronic components can thus be moderated.

The supercapacitor layers are joined to the structural battery layers in order to regulate the energy supply, and also connected to the structural fuel cell which generates electric energy from the fuel cell process.

### BRIEF DESCRIPTION OF THE DRAWINGS

Working examples will be explained in more detail with the aid of the accompanying schematic drawings. The drawings show:

FIG. 1 is a working example of an aircraft;

FIG. 2 is a working example of a composite laminate;

FIG. 3 is a detailed view of an energy generation layer structure;

FIG. 4 is a detailed view of a supercapacitor layer structure;

FIG. 5 is a detailed view of a battery layer structure;

FIG. 6 is a depiction of the energy supply to aircraft components;

FIG. 7 is a variant of the energy supply to aircraft components; and

FIGS. 8A and 8B are a working example of a process for producing a composite laminate structure.

### DETAILED DESCRIPTION OF THE PREFERRED EMBODIMENTS

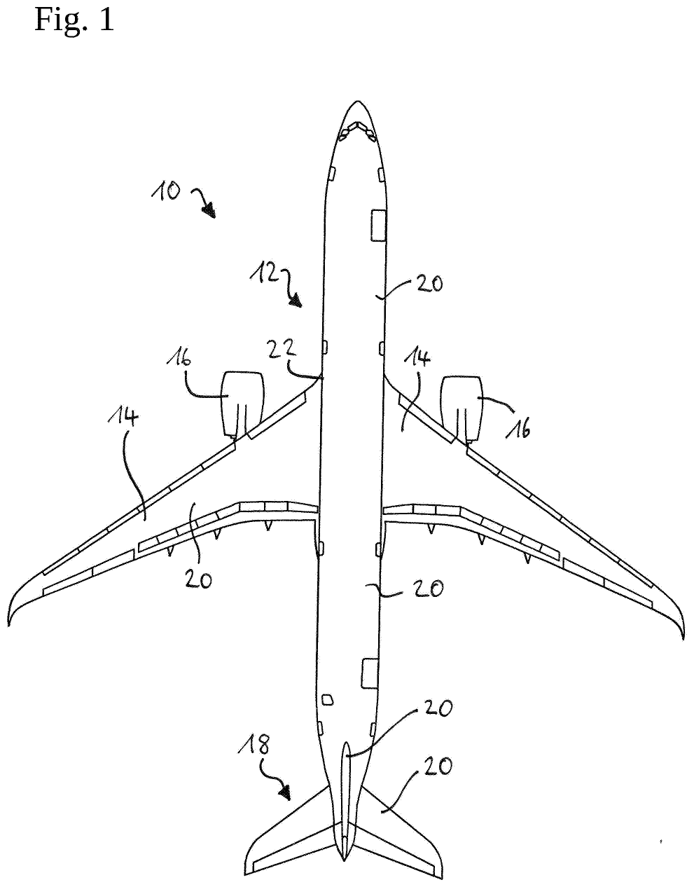

Reference is made below to FIG. 1 which shows a working example of an aircraft 10. The aircraft 10 comprises a fuselage structure 12 to which a pair of wings 14 are attached. At least one engine nacelle 16 is preferably attached to each wing 14. Furthermore, the aircraft 10 has a tailplane 18, the configuration of which is known per se.

In the present case, the fuselage structure 12, the wings 14, the engine nacelle 16 and the tailplane 18 are made predominantly of a composite laminate structure 20.

Here, the abovementioned regions can each be made of one or more exterior panels 22 which contain the composite laminate structure 20.

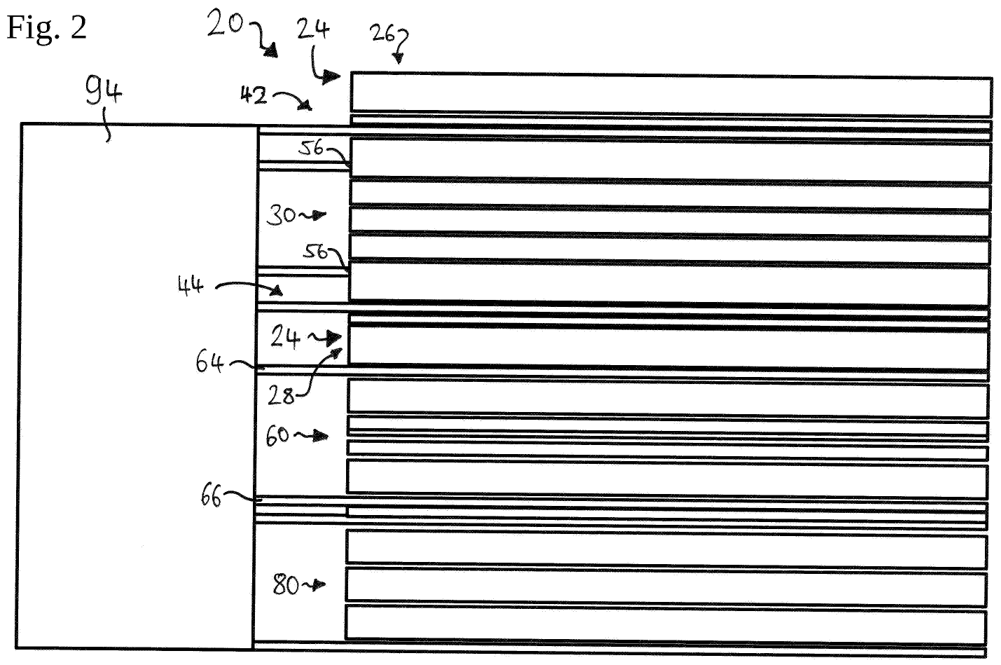

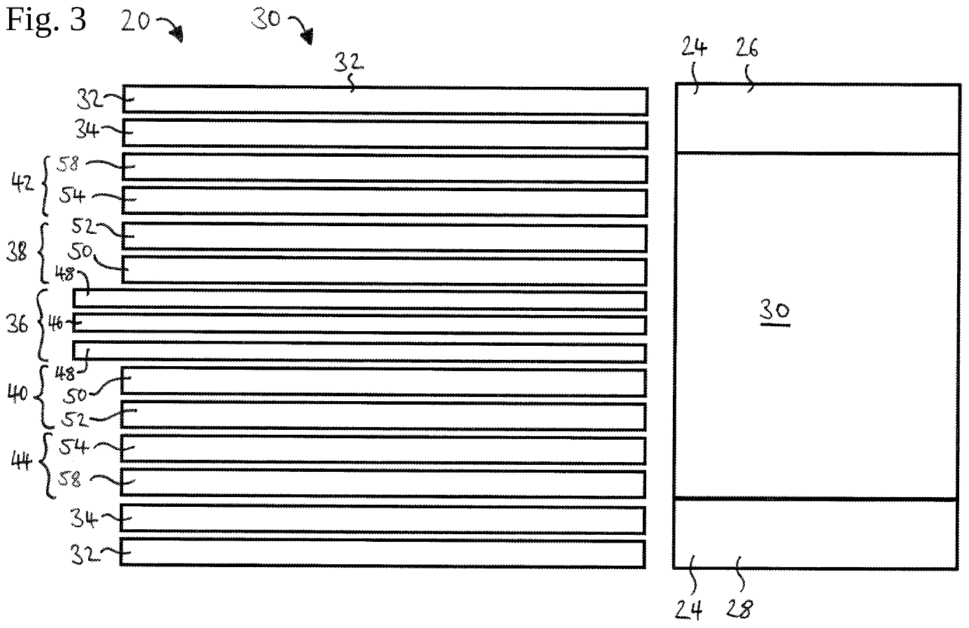

Reference is made below to FIG. 2, which depicts the overall structure of the composite laminate structure 20, and FIG. 3. The structural composite laminate structure 20 contains a plurality of likewise structural layer structures which are each stacked on top of one another.

The composite laminate structure 20 contains a structural fiber composite layer structure 24. The fiber composite layer structure 24 has an outer fiber composite region 26 and an integrated fiber composite region 28.

The composite laminate structure 20 contains an energy generation layer structure 30 which is embedded in the fiber composite layer structure 24. In other words, the energy generation layer structure 30 is arranged between the outer fiber composite region 26 and the integrated fiber composite region 28 and joined thereto.

The outer fiber composite region 26 and the integrated fiber composite region 28 preferably have an identical configuration. Each fiber composite region 26, 28 preferably comprises a plurality of carbon fiber sublayers 32 and a plurality of glass fiber insulation sublayers 34. The carbon fiber sublayers 32 and the glass fiber insulation sublayers 34 are stacked on top of one another in such a way that the respective glass fiber insulation layer 34 faces the energy generation layer structure 30 and is applied thereto, while the carbon fiber sublayers 32 adjoin the glass fiber insulation sublayers 34.

The energy generation layer structure 30 comprises an ion-conducting separation layer 36, a first gas distributor layer 38 and a second gas distributor layer 40. The ion-conducting separation layer 36 is arranged between the first and second gas distributor layers 38, 40. A cathode layer 42 is arranged adjoining the first gas distributor layer 38. An anode layer 44 is arranged adjoining the second gas distributor layer 40.

The ion-conducting separation layer 36 comprises at least one proton exchange membrane 46 and a catalyst membrane 48 on each side of the proton exchange membrane 46.

The proton exchange membrane 46 contains a polymer electrolyte known per se.

The catalyst membrane 48 preferably contains platinum or a mixture of platinum and ruthenium, platinum and nickel or platinum and cobalt, which are usually employed in hydrogen-oxygen fuel cells, as a catalyst.

The first gas distributor layer 38 and the second gas distributor layer 40 preferably have an identical structure and contain a microporous structural sublayer 50 and a gas diffusion sublayer 52. The microporous structural sublayer 50 adjoins the catalyst membrane 48. The gas diffusion sublayer 52 has been applied to the microporous structural sublayer 50 and adjoins the cathode layer 42 or the anode layer 44.

The cathode layer 42 and the anode layer 44 have an essentially identical configuration.

The cathode layer 52 contains bipolar plate sublayers 54. The bipolar plate sublayer 54 is, for example, made of carbon fiber-reinforced polymer and contains a gas channel 56 which has been structured by removal of material by laser.

Furthermore, the cathode layer 42 and the anode layer 44 contains a current collector sublayer 58. The current collector sublayer 58 serves to electrically connect the energy generation layer structure to a control unit (will be described in more detail) and can contain a metal, for example copper in the form of a copper braid.

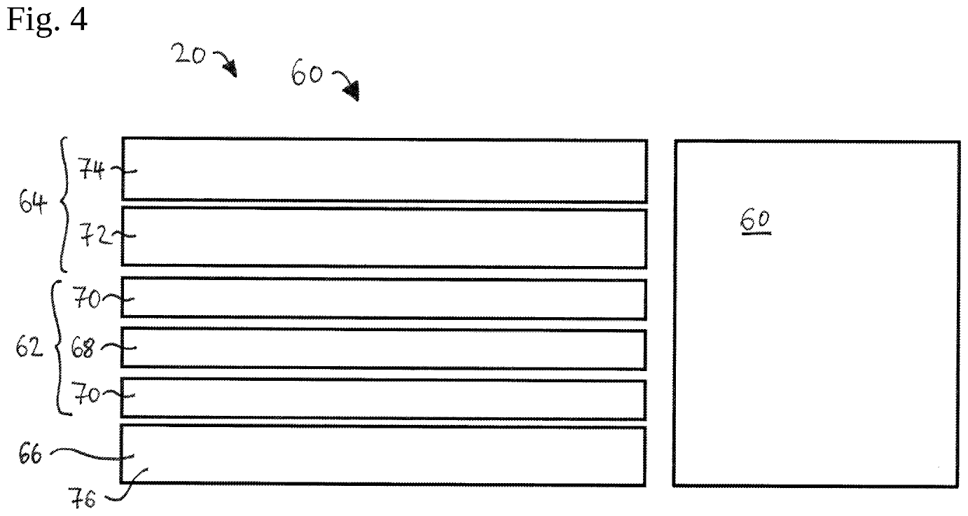

Reference will be made below to FIG. 2 and FIG. 4. The composite laminate structure 20 contains a supercapacitor layer structure 60. The supercapacitor layer structure is likewise configured as structural layer structure and is applied to the fiber composite layer structure 24.

The supercapacitor layer structure 60 contains a supercapacitor layer 62, a first current collector layer 64 and a second current collector layer 66. The supercapacitor layer 62 is arranged between the first and second current collector layers 64, 66. The supercapacitor layer 62 contains at least one separator sublayer 68 composed of a glass fiber material. The supercapacitor layer 62 contains a plurality of electrolyte sublayers 70 which are arranged on the two sides of the separator sublayer 68. The electrolyte sublayer 70 contains a solid polymer electrolyte, which is known per se.

The first current collector layer 64 adjoins one of the electrolyte sublayers 70 and contains a structural carbon fiber electrode 72. Furthermore, the first current collector layer 64 contains a structural current collector 74. The current collector 74 preferably contains a metal, for example in the form of a copper braid, and can be connected to a control unit or controller.

The second current collector layer 66 likewise contains a carbon fiber electrode 76. The carbon fiber electrode 76 is likewise able to be connected to a control unit. The second current collector layer 66 can, in one variant, likewise comprise a metal-containing current collector.

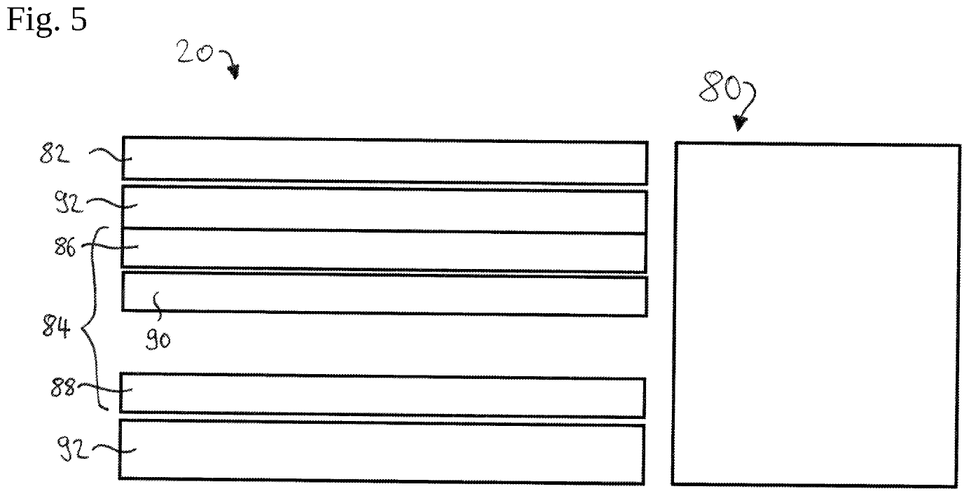

Reference will be made below to FIG. 2 and FIG. 5. The composite laminate structure 20 additionally contains a structural battery layer structure 80.

The battery layer structure 80 contains a glass fiber separator 82 which separates the battery layer structure 80 from the supercapacitor layer structure 60. Furthermore, the battery layer structure 80 contains a battery layer 84. The battery layer 84 comprises a negative electrode sublayer 86 and a positive electrode sublayer 88. Both the negative electrode sublayer 86 and the positive electrode sublayer 88 are made of a carbon fiber-reinforced composite. The negative electrode sublayer 86 and the positive electrode sublayer 88 are separated by a separator sublayer 90 which is made of glass fibers. Each sublayer in the battery layer 84 contains a solid polymer electrolyte.

The battery layer structure 80 additionally contains two current collector sublayers 92 which can contain a metal braid. The current collector sublayers 92 can be connected to a control unit.

The composite laminate structure 20 additionally contains a control unit or controller 94. The control unit 94 can be a microcontroller which controls power generation, power storage and power retrieval from the composite laminate structure 20. The control unit 94 is furthermore responsible for supplying the energy generation layer structure 30 with hydrogen and oxygen for energy production. The control unit 94 is, in particular, configured as flat integrated microcontroller which can, for example, be applied at the side of the composite laminate structure. The control unit 94 can also provide connections for diagnostic purposes or supply purposes.

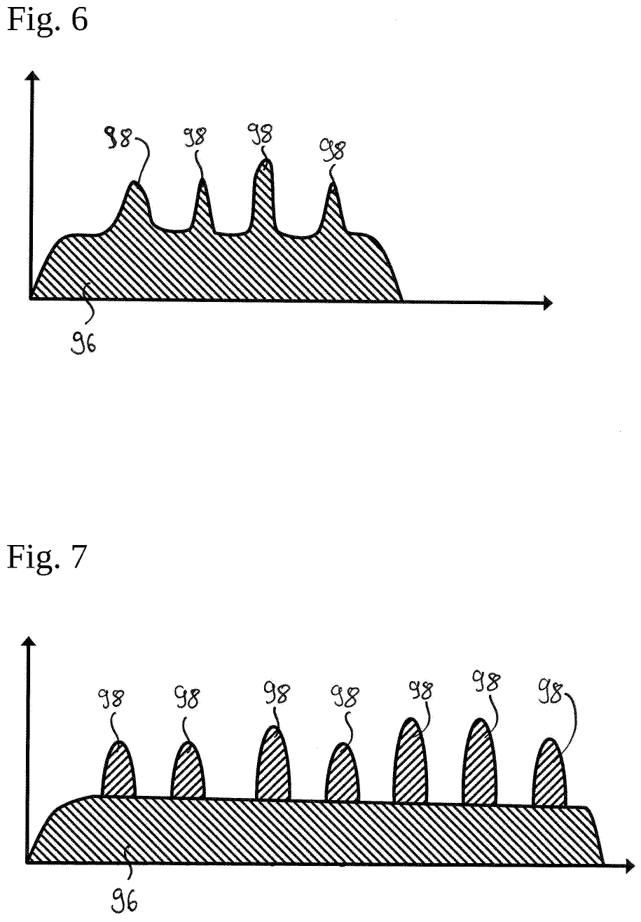

Possible energy supply scenarios will be described in more detail below with reference to FIG. 6 and FIG. 7.

As depicted in FIG. 6, the power uptake of the aircraft 10 can have a plurality of power peaks 98 in addition to the base load 96. Both the base load 96 and the power peaks 98 are provided by the structural battery. The control unit 94 in this case controls the power offtake from the structural battery.

In contrast thereto, as depicted in FIG. 7, the base load 96 is provided by the structural battery while the power peaks 98 are provided by the structural supercapacitor. The control unit 94 controls these correspondingly.

It should be noted that for longer-term energy supply, the control unit 94 supplies the energy generation layer structure 30 with gases and controls this structure in such a way that a sufficient quantity of energy is stored in the structural battery or the structural supercapacitor during the duration of normal operation.

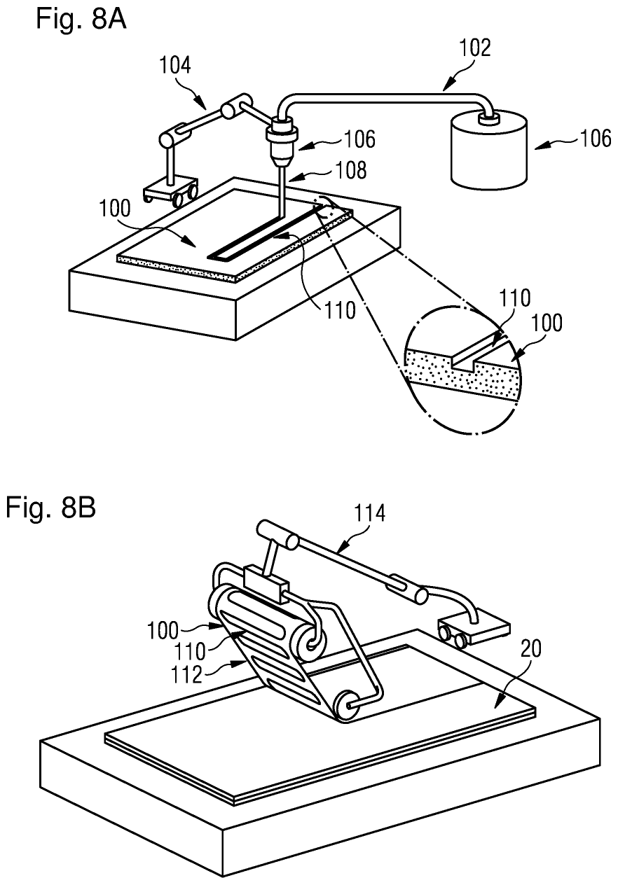

Reference will be made below to FIGS. 8A and 8B which schematically shows a working example of a process for producing the composite laminate structure 20.

Firstly (FIG. 8A), individual fiber sublayers 100 can be structured by means of a laser structuring unit 102. The fiber sublayer 100 has a usual thickness of from 0.1 mm to 0.3 mm. A robotic arm 104 can direct a laser beam 108 produced by a laser apparatus 106 onto the fiber sublayer 100 for the purpose of removing material and can thus create a meandering gas channel 110.

The composite laminate structure 20 is produced by laying down fiber tapes 112 or fiber sublayers (FIG. 8B), e.g., the fiber sublayers 100, using an appropriate fiber laying machine 114. For example, the fiber sublayers 100 can be laid down onto the existing part of the composite laminate structure 20 in order to produce part of the energy generation layer structure 30.

After the layer-by-layer laying down of the entire composite laminate structure 20, the latter is consolidated in an autoclave so as to form an aircraft component, for example an exterior panel 22. The aircraft component has an energy generation function, an energy storage function and an energy distribution function.

A composite laminate structure 20 which contains a structural fuel cell 30, a structural supercapacitor 60 and a structural battery 80 is provided by means of the above-described measures. Each one of the components 30, 60, 80 has a self-supporting configuration so that aircraft components, for example exterior panels 22, can be produced therefrom. The aircraft components are able to generate electric energy by means of the structural fuel cell 30 and distribute it over the entire aircraft 10 without cables. Furthermore, short-term power peaks 98 can be supplied by the structural supercapacitor 60, while the base load 96 is supplied by the structural battery 80.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE NUMERALS

10 Aircraft
12 Fuselage structure
14 Wing
16 Engine nacelle
18 Tailplane
20 Composite laminate structure
22 Exterior panel
24 Fiber composite layer structure
26 Outer fiber composite region
28 Integrated fiber composite region
30 Energy generation layer structure (fuel cell)
32 Carbon fiber sublayer
34 Glass fiber insulating sublayer
36 Ion-conducting separation layer
38 First gas distributor layer
40 Second gas distributor layer
42 Cathode layer
44 Anode layer
46 Proton exchange membrane
48 Catalyst membrane
50 Microporous structural sublayer
52 Gas diffusion sublayer
54 Bipolar plate sublayer
56 Gas channel
58 Current collector sublayer
60 Supercapacitor layer structure
62 Supercapacitor layer
64 First current collector layer
66 Second current collector layer
68 Separator sublayer
70 Electrolyte sublayer
72 Carbon fiber electrode
74 Current collector
76 Carbon fiber electrode
80 Battery layer structure
82 Glass fiber separator
84 Battery layer
86 Negative electrode sublayer
88 Positive electrode sublayer
90 Separator sublayer
92 Current collector sublayers
94 Control unit/controller
96 Base load
98 Power peak
100 Fiber sublayer
102 Laser structuring unit
104 Robotic arm
106 Laser apparatus
108 Laser beam
110 Gas channel
112 Fiber tape
114 Fiber laying machine

1. A structural composite laminate structure for an aircraft component, wherein the composite laminate structure comprises a plurality of structural layer structures stacked on top of one another, comprising:
a structural fiber composite layer structure made of a fiber composite material;
a structural energy generation layer structure which forms a structural fuel cell, and which is applied to the fiber composite layer structure;
a structural supercapacitor layer structure which forms a structural supercapacitor; and
a structural battery layer structure which forms a structural battery, and which is applied to the supercapacitor layer structure.

2. The composite laminate structure according to claim 1, wherein the fiber composite layer structure has an outer fiber composite layer region which is arranged on an outside of the composite laminate structure, which forms an outer skin, and which is applied to the energy generation layer structure.

3. The composite laminate structure according to claim 1, wherein the fiber composite layer structure has an integrated fiber composite layer region which is arranged as fiber composite intermediate layer between the energy generation layer structure and the supercapacitor layer structure.

4. The composite laminate structure according to claim 1, wherein the fiber composite layer structure comprises an insulating fiber composite layer which is applied to the energy generation layer structure.

5. The composite laminate structure according to claim 1, wherein the energy generation layer structure comprises an ion-conducting separation layer, a first gas distributor layer and a second gas distributor layer, which each adjoin the ion-conducting separation layer and distribute gas in a layer plane, and an electrically conductive cathode layer, which adjoins the first gas distributor layer, and an electrically conductive anode layer, which adjoins the second gas distributor layer.

6. The composite laminate structure according to claim 5, wherein the ion-conducting separation layer comprises a plurality of separation layer sublayers, where one separation layer sublayer is a proton exchange membrane and at least one separation layer sublayer applied to the proton exchange membrane is a catalyst membrane coated with a catalyst suitable for a fuel cell reaction.

7. The composite laminate structure according to claim 5, wherein at least one of the first gas distributor layer or the second gas distributor layer comprise a plurality of gas distributor sublayers, where at least one of
a part of the gas distributor sublayers facing away from the ion-conducting separation layer forms a gas diffusion sublayer, or
a part of the gas distributor sublayers applied to the ion-conducting separation layer forms a microperforated sublayer.

8. The composite laminate structure according to claim 5, wherein at least one of the cathode layer or the anode layer have a plurality of bipolar plate sublayers and current collector sublayers, where each bipolar plate sublayer is a composite sublayer which contains at least one gas channel

9. The composite laminate structure according to claim 5, wherein at least one of the cathode layer or the anode layer have a plurality of bipolar plate sublayers and current collector sublayers, where each current collector sublayer is a composite sublayer containing a metal.

10. The composite laminate structure according to claim 1, wherein the supercapacitor layer structure comprises a first current collector layer and a second current collector layer between which a supercapacitor layer is arranged, where the first current collector layer is applied adjoining the energy generation layer structure and where the second current collector layer is applied adjoining the battery layer structure.

11. The composite laminate structure according to claim 10, wherein at least one of the first current collector layer or the second current collector layer contains an electrode sublayer which is composed of carbon fibers and is applied to the supercapacitor layer.

12. The composite laminate structure according to claim 10, wherein the supercapacitor layer comprises a plurality of electrolyte sublayers, where at least two electrolyte sublayers are each applied separately from one another to the first current collector layer and to the second current collector layer, and at least one separator sublayer, where the separator sublayer electrically insulates at least two electrolyte sublayers from one another and is applied to these.

13. The composite laminate structure according to claim 6, wherein one of the current collector layers comprises a current collector sublayer which contains metal and is applied adjoining the fiber composite layer structure.

14. The composite laminate structure according to claim 1, wherein the battery layer structure comprises a battery layer which comprises a negative electrode sublayer and a positive electrode sublayer which are separated from one another by a separator sublayer, where each sublayer of the battery layer contains a structural electrolyte.

15. The composite laminate structure according to claim 14, wherein the battery layer structure comprises at least one of
a plurality of current collector sublayers which are each applied to the negative electrode sublayer and the positive electrode sublayer, or
an insulating glass fiber separator which separates the battery layer structure from the supercapacitor layer structure and is applied thereto.

16. The composite laminate structure according to claim 1, further comprising an integrated controller which is configured to control a generation, storage and retrieval of electric energy by the energy generation layer structure, the supercapacitor layer structure and the battery layer structure, where the controller is electrically conductively connected to these layer structures and where the controller is fluidically connected to the energy generation layer structure to introduce and discharge fluids.

17. An aircraft component, wherein the aircraft component is made of a composite laminate comprising a composite laminate structure according to claim 1.

18. An aircraft containing at least one aircraft component according to claim 17.

19. A process for producing an energy generation layer structure for a composite laminate structure, according to claim 4, comprising the steps:
forming the energy generation layer structure by laying down fiber sublayers,
forming the first gas distributor layer or the second gas distributor layer by laying down carbon fiber sublayers in which a gas channel has been formed by removal of material.

20. The process according to claim 19, wherein the removal of material is performed by laser.
